(19) United States
(12) Patent Application Publication
(10) Pub. No.: US 2015/0111431 A1
(43) Pub. Date: Apr. 23, 2015

(54) TEMPERATURE SENSITIVE CIGARETTE LIGHTER ADAPTER SAFETY CIRCUIT

(71) Applicants: ROBERT F. WENTINK, CHICAGO, IL (US); HUANG TAI GUANG, WESTCHESTER, IL (US); CAO XINLIANG, WESTCHESTER, IL (US); JOSEPH KEATING, BROOMFIELD, CO (US)

(72) Inventors: ROBERT F. WENTINK, CHICAGO, IL (US); HUANG TAI GUANG, WESTCHESTER, IL (US); CAO XINLIANG, WESTCHESTER, IL (US); JOSEPH KEATING, BROOMFIELD, CO (US)

(73) Assignee: ICC-NEXERGY, INC., WESTCHESTER, IL (US)

(21) Appl. No.: 14/521,745

(22) Filed: Oct. 23, 2014

Related U.S. Application Data
(60) Provisional application No. 61/894,753, filed on Oct. 23, 2013.

(51) Int. Cl. H01R 33/95; H01R 13/696; H01R 13/66

(52) U.S. Cl. CPC H01R 33/95; H01R 13/6683; H01R 13/696
USPC 439/620.08; 29/623

(57) ABSTRACT

Briefly, the present invention relates to a cigarette lighter adapter (CLA) configured to be received in a CLA socket in a vehicle. The CLA includes a positive contact and a negative contact and housing, for example, a plastic housing. The negative contacts are formed as springs, which extend from the housing and are configured to exert spring force against an interior wall of a socket to assure a solid connection. The positive contact is also formed as a spring and is connected in series with a thermal sensor. In accordance with an important aspect of the invention, the thermal sensor, for example, a bi-metallic strip, is in thermal contact with a tip, which is serially connected to the positive contact and which extends outwardly from the plastic housing, the thermal sensor causes the CLA to be disconnected from the socket when an excessive temperature is sensed. The thermal sensor is selected to disconnect the CLA from the socket at a safe temperature, for example, a temperature below the melting temperature of the plastic housing. In accordance with another important aspect of the invention, the positive contact is formed as a spring which is connected by way of soldering to a printed circuit board, thermal sensor and the tip in order to eliminate high resistance pressure contact connections.

### CROSS REFERENCE TO RELATED APPLICATIONS

This application is a continuation of and claims the benefits of U.S. Provisional Patent Application No. 61/894,753, filed on Oct. 23, 2013, hereby incorporated by reference.

### BACKGROUND OF THE INVENTION

### 1. Field of the Invention

The present invention relates to a cigarette lighter adapter (CLA) for connection to a CLA socket, available on most vehicles, and more particularly to CLA with a built in safety circuit which includes a temperature sensor in thermal contact with the tip of the CLA which disconnects the CLA from the socket during conditions when the tip of the CLA experiences excessive temperatures.

Cigarette lighter adapter (CLA) sockets are normally found in vehicles. The CLA sockets are configured to receive a CLA. These sockets were previously used for cigarette lighters configured as cigarette lighters. Today the sockets are used as 6 volt, 12 volt and 24 volt power sources for various devices including battery chargers for cell phones and other devices with higher power, such as portable oxygen concentrators. However, other voltages are anticipated. Such CLAs include a positive contact and a negative contact housed in a plastic housing. The positive contact is formed as a spring and used to maintain a lateral spring force in order to maintain a good spring force between tip and the socket in order to maintain a good positive connection therebetween. The negative contact is formed as a pair of springs which extend outwardly from the CLA housing and are configured to provide a secure connection within the socket.

As the spring force on the connection between the socket and the positive contact decreases due to, for example, insertions and/or vibrations, the CLA connection can become loose. As a result of the loose connection, the CLA draws more current, thereby heating up the tip. The loose connection provides increased contact resistance relative to the positive contact. Since the CLAs are used to power constant power loads, as the contact resistance increases, the voltage supplied to the load will decrease causing an increase in current. The increased current results in increased heat in the form of i²R losses in the tip of the CLA. As a result, such a condition has been known to melt the plastic housing of the CLA.

There are also known problems with the tip connected to the positive contact. In particular, vibration can cause the CLA to wiggle out of the socket. As the CLA wiggles out of the socket, the spring force between the tip and the socket is reduced causing a poor connection between the tip and the socket resulting in increased contact resistance and localized heating at the tip.

The problem with tip is illustrated in FIGS. 11A and 11B. FIG. 11A illustrates an exemplary CLA in a normal condition. The CLA is illustrated with a positive contact spring 10 mechanically and electrically connected to a printed circuit board 12. The printed circuit board 12 is used to electrically connect the positive contact 10 to the tip 14.

As shown in FIG. 11A, the positive contact spring 10 is compressed, thereby providing a positive contact force on the tip 14. In this condition, the positive contact spring 10 is compressed resulting in a positive contact force between the tip 14 and the socket. FIG. 11B illustrates a condition in which the CLA has wiggled out of the socket, for example, due to vibrations. In this condition, the positive spring contact 10 is relaxed exerting no spring force on the tip 14 relative to the socket. In such a condition, the contact resistance at the tip 14 increases causing localized heating at the tip 14. This localized heating can rise to a temperature that meets or exceeds the melting point of the plastic housing.

Known CLAs include a fuse for disconnecting the CLA from the socket based upon overcurrent. However, the fuses do not provide protection against overheating due to a loose connection. More particularly, such fuses are normally designed to protect against relative high over-currents, for example, due to a fault of the load connected to the CLA. The loose connection problem described above has not been known to draw enough current to trip the fuse. As such, the increased heat in the tip of the CLA has been known to melt the CLA plastic housings. Unfortunately, lowering the trip rating of the fuse can result in spurious trips of the fuse.

Another known problem with CLAs relates to the high resistance, pressure contact connections between the various components connected in series with the positive contact. In known CLAs, these connections are made by way of various methods, such as screw connections, connections by way of compression springs and other types of connections that can result in increased resistance and increased heating under abnormal conditions. For example, in one known CLA, the positive wire is connected to the positive contact with a screw. In such a configuration, the screw may loosen due to vibration over time. This situation will result in increased resistance and heating at the connection, which will raise the temperature of the CLA housing, potentially contributing to the problem discussed above or individually causing catastrophic failure.

In yet other known CLAs, a separate spring is used that is in contact with the positive contact and a fuse, which, in turn, is in contact with the tip. The spring biases the fuse and the tip in a lateral direction. There are no hard connections between the spring and the fuse or between the fuse and the tip. Depending on the spring force of the spring, these connections are not ideal and will likely result in increased resistance and heating with respect to an ideal connection, such as a solder connection.

Thus, there is a need for providing protection of the CLA during conditions when the CLA becomes loosely connected within the socket and one which eliminates resistive pressure contact connections of the components connected to the positive contact.

### SUMMARY OF THE INVENTION

Briefly, the present invention relates to a cigarette lighter adapter (CLA) configured to be received in a CLA socket in a vehicle. The CLA includes a positive contact and a negative contact and housing, for example, a plastic housing. The negative contacts are formed as springs, which extend from the housing and are configured to exert spring force against an interior wall of a socket to assure a solid connection. The positive contact is also formed as a spring and is connected in series with a thermal sensor. In accordance with an important aspect of the invention, a thermal sensor, for example, a bi-metallic strip (also known in the industry as a thermostat), is in thermal contact with a tip, which is serially connected to the positive contact and extends outwardly from the plastic housing, The thermal sensor causes the CLA to be disconnected from the socket when an excessive temperature is sensed. The thermal sensor is selected to disconnect the CLA from the socket at a temperature below the melting temperature of the plastic housing. In accordance with another important aspect of the invention, the positive contact is formed as a spring which is connected by way of a low resistance connection to a printed circuit board, thermal sensor and the tip in order to eliminate high resistance, pressure contact type connections.

### DESCRIPTION OF THE DRAWING

These and other advantages of the present invention will be readily understood with reference to the following specification and attached drawing wherein:

FIG. 1 is an exploded perspective view of an exemplary cigarette lighter adapter (CLA) in accordance with the present invention.

FIG. 2 is a plan view of a partially assembled CLA in accordance with the present invention.

FIG. 3 is a plan view of an exemplary thermal sensor and printed circuit board in accordance with the present invention.

FIG. 4 is a perspective view of an exemplary positive plug and screw cap in accordance with the present invention.

FIG. 5 is a plan view of an exemplary ferrule for use with the present invention.

FIG. 6 is an isometric view of an exemplary positive and negative contact in accordance with the present invention.

FIG. 7 is an isometric view of an exemplary housing for use with the present invention.

FIG. 8 is an isometric view of an exemplary assembled CLA in accordance with the present invention.

FIG. 9 illustrates an exemplary thermal test curve of the CLA adapter in accordance with the invention illustrating the response of the thermal sensor in a normal condition in which the electrical contact with the positive contact is normal and the temperatures of the adapter are normal and stable.

FIG. 10 illustrates an exemplary thermal test curve of the CLA adapter in accordance with the invention illustrating the response of the thermal sensor in an abnormal case in which the electrical contact with the positive tip is abnormal and the temperatures increase to an abnormal temperature in which the thermal sensor operates and disconnects the input power causing the temperature to drop until the thermal sensor is reset in which the input power is reconnected and the cycle repeats.

FIG. 11A illustrates a simplified cut away view of a CLA illustrating the positive contact spring in a compressed condition and a normal contact force between the tip and the socket.

FIG. 11B is similar to FIG. 11A but showing the positive contact spring in a relaxed position and an abnormal or lack of contact force between the tip and the socket.

### DETAILED DESCRIPTION

The present invention relates to a cigarette lighter adapter (CLA) configured to be received in a CLA socket in a vehicle. The CLA includes a positive contact and a negative contact and housing, for example, a plastic housing. The negative contacts are formed as springs, which extend from the housing and are configured to exert spring force against an interior wall of a socket to assure a solid connection. The positive contact is also formed as a spring and is connected in series with a thermal sensor. In accordance with an important aspect of the invention, a thermal sensor, for example, a bi-metallic strip is in thermal contact with a tip, which is serially connected to the positive contact and extends outwardly from the plastic housing. The thermal sensor causes the CLA to be electrically disconnected from the socket when an excessive temperature is sensed. The thermal sensor is selected to disconnect the CLA from the socket at a safe temperature, for example, a temperature below the melting temperature of the plastic housing. In accordance with another important aspect of the invention, the positive contact is formed as a spring which is connected by way of a low resistance connection, for example, by soldering, to a printed circuit board, thermal sensor and the tip in order to eliminate high resistance, pressure contact connections.

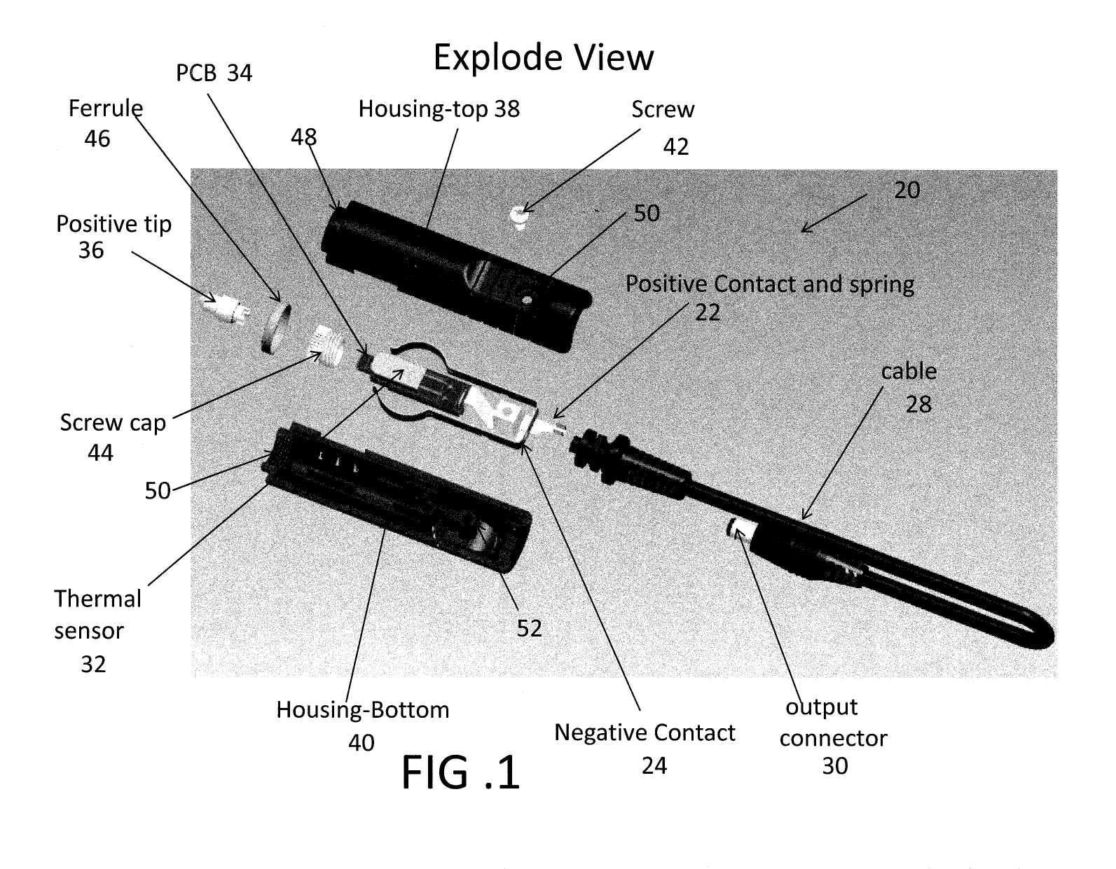

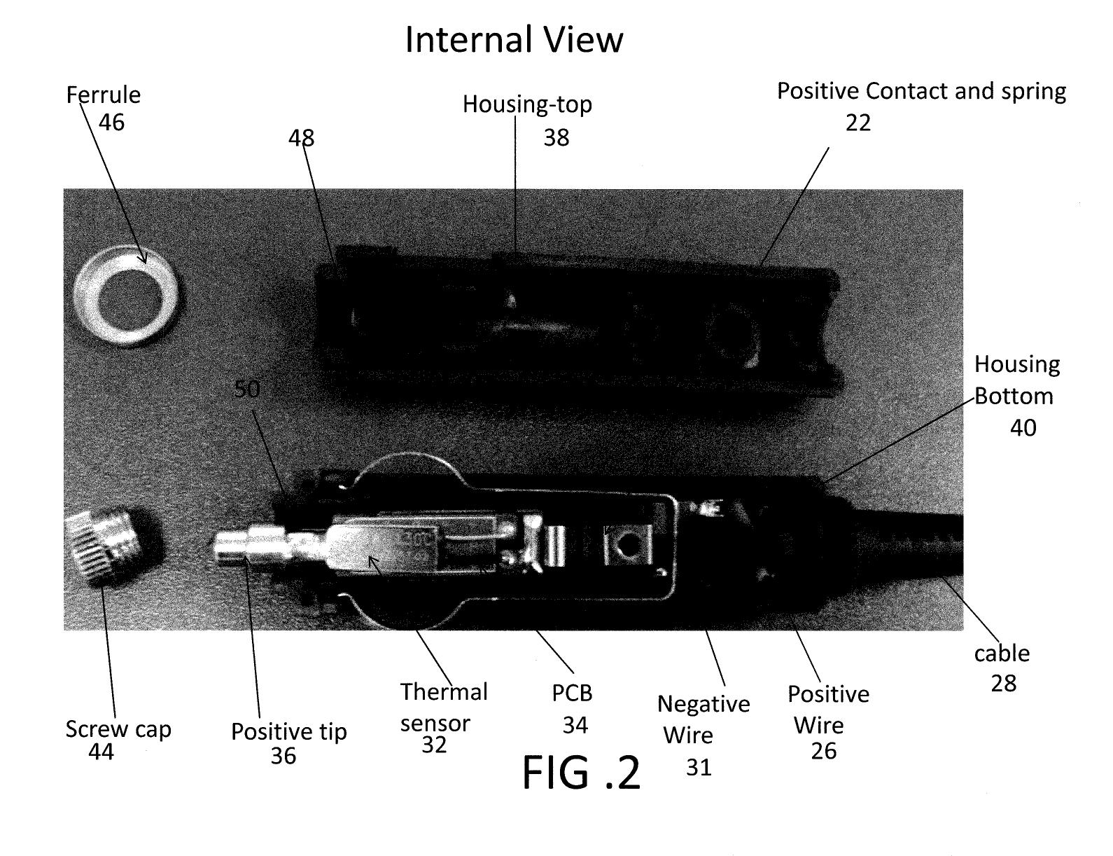

Referring first to FIG. 1, a partial CLA assembly in accordance with the present invention is shown and generally identified with the reference numeral 20. The CLA assembly 20 includes a positive spring contact 22 and a negative spring contact 24. The positive contact 22 is adapted to be connected to a positive wire 26 (FIG. 2) of the cable 28 while the negative contact 24 is adapted to be connected to a negative wire 31 of the cable 28.

The circuit includes a thermal sensor 32, which includes a thermal sensing surface. One end of the positive contact 22 is connected to a thermal sensor 32, for example, by way of a printed circuit board (PCB) 34. These connections are made with low resistance joint connections, such as solder, to eliminate potentially loose connections due to vibrations. In addition, the sensing surface of the thermal sensor 32 is placed in thermal contact with an electrically and thermally conductive tip 36, for example, direct thermal contact by way of soldering, as shown in FIG. 2. The tip 36 may be made from various thermally and electrically conductive materials, for example, brass or other thermally and electrically conductive metals. The positive contact 22 is also connected to the PCB by way of low resistance joint connections, such as solder. The tip 36 is directly connected to the thermal sensor 32, for example by way of low resistance joint connections. As such all of the components attached to the positive spring contact 22 are made with low resistance joint connections. In addition, the PCB 34, thermal sensor 32 and the tip 36 all move together as a unit and are all under the influence of the lateral spring force of the positive contact spring 22.

With the configuration discussed above, the positive contact spring 22 provides a lateral contact force to move the PCB 34, the thermal sensor 32 and the tip 36 as a unit. With all of the components connected to the positive contact spring with solder, the potential for loose connections due to vibrations is eliminated. As such localized heating due to a loose connection of these components is eliminated.

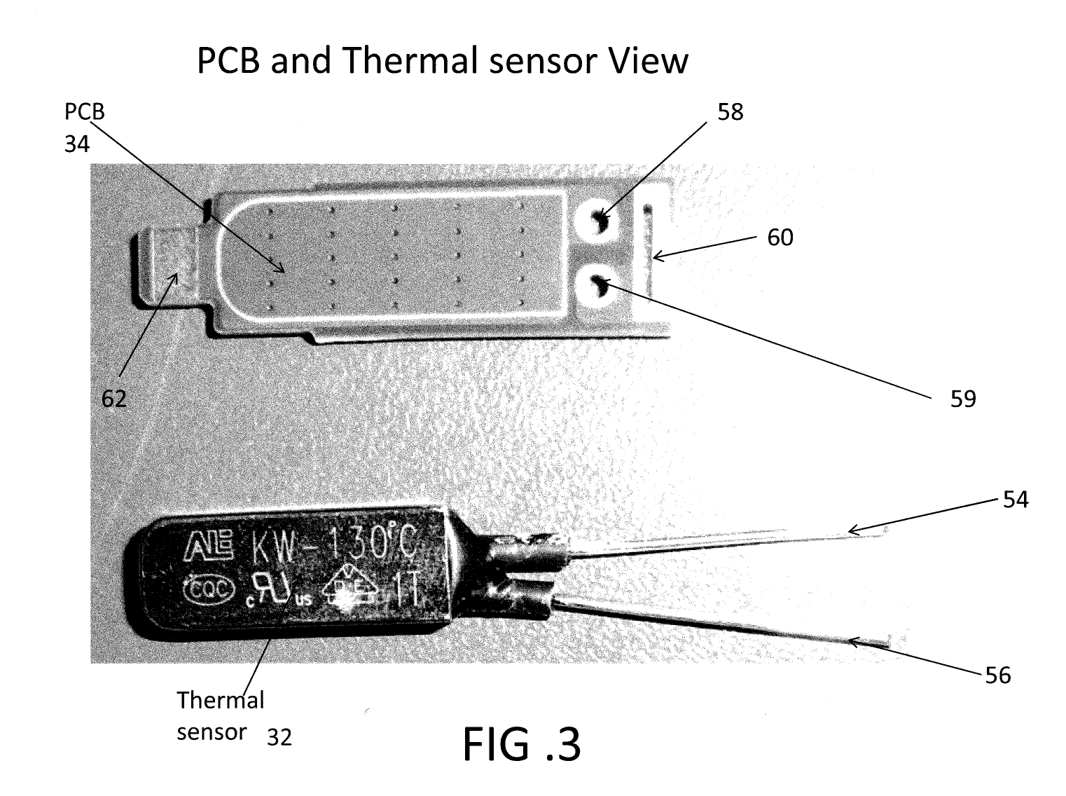

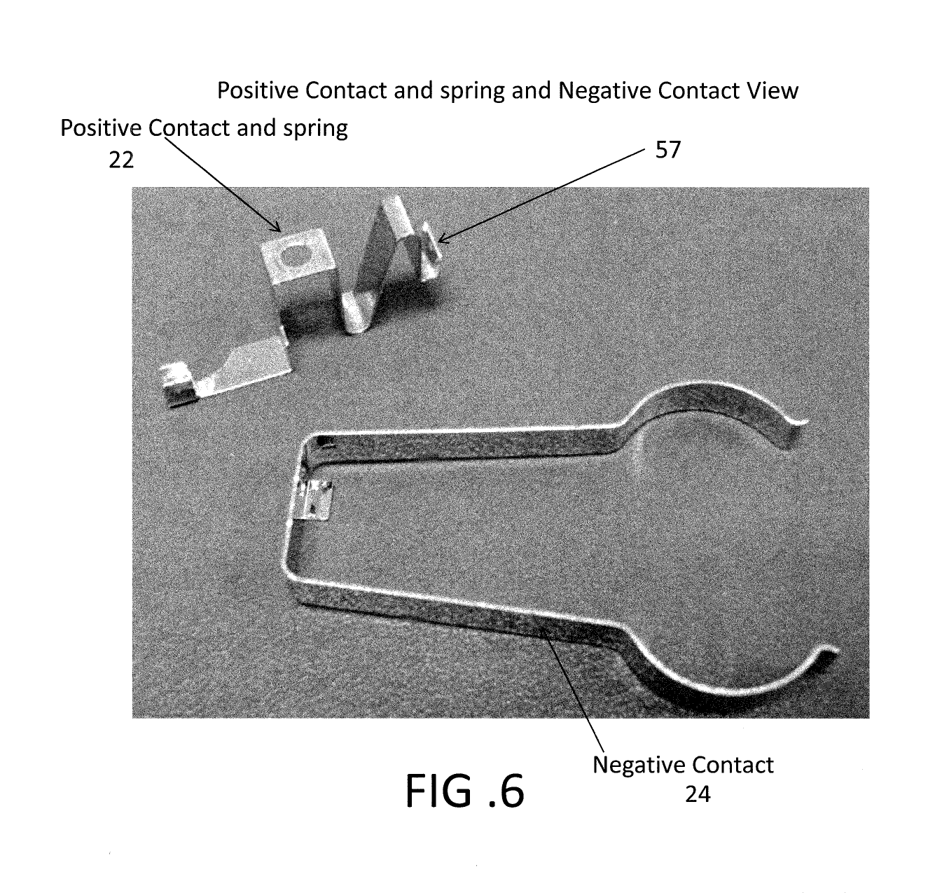

As shown best in FIGS. 2 and 3, the thermal sensor 32 may be connected to the circuit by way of the printed circuit board 34. Specifically, a pair of extending wires 54 and 56 from the thermal sensor 32 is electrically connected to the conductive holes 58 and 59 in the PCB 34, for example, by soldering. An extending tab 57 (FIG. 6) of the positive contact 22 is connected to a conductive slot 60 (FIG. 3) on the PCB 34, by soldering, for example. The PCB 34 is configured to provide a series connection between the positive contact 22 and the thermal sensor 32. One of the wires of 54 and 56 of the thermal sensor 32 is electrically connected to a contact 62 (FIG. 3).

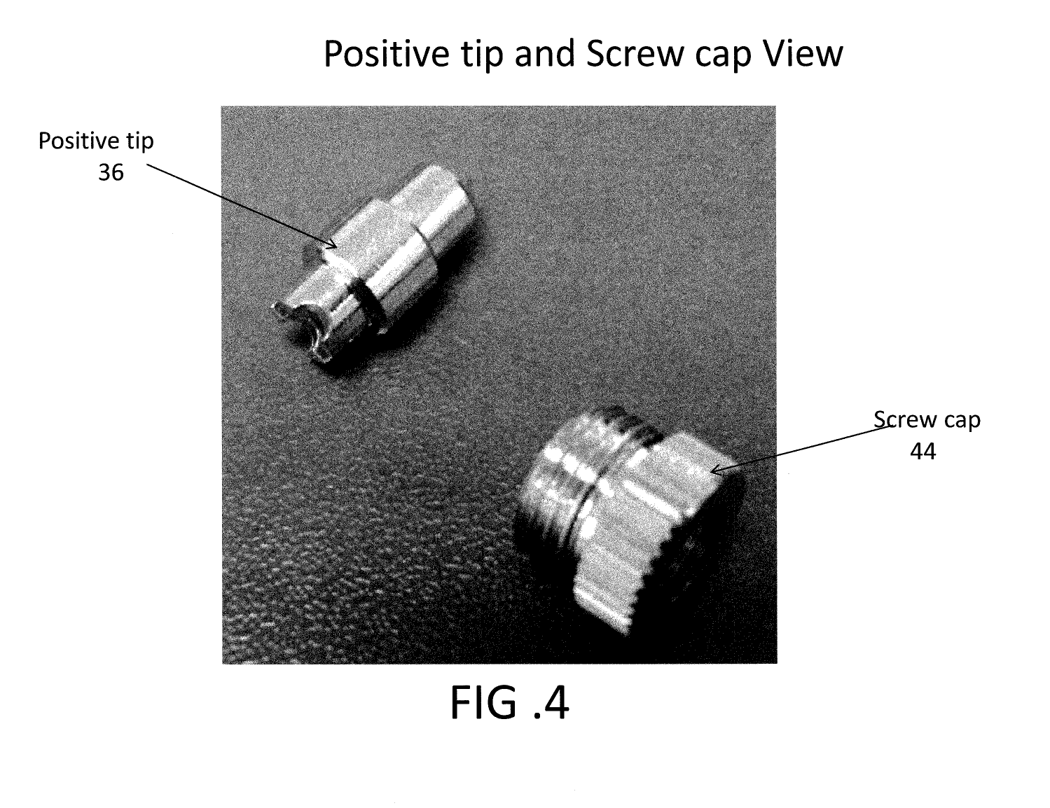

An electrically and thermally conductive tip 36 (FIG. 4) is electrically connected to an electrical contact surface contact 62 on the PCB 32 to provide a series electrical connection from the tip 36 through the thermal sensor 32 and to the positive wire 54. As mentioned above, the thermal sensor 32 is placed in thermal contact with the tip 36, for example, by soldering the housing of the thermal sensor 32 directly to the tip 36. As such, the thermal sensor 32 will be responsive to the temperature of the tip 36. When the temperature of the tip exceeds a predetermined temperature, for example, a temperature less than the melting temperature of the housing 38, 40, the thermal; sensor 32 will electrically disconnect the CLA 20 from the vehicle socket (not shown).

Various types of thermal sensors can be used. For example, bi-metallic temperature sensors, thermocouples, resistive temperature devices, as well as other types of thermal sensors are suitable. In accordance with the invention, it is important that the temperature sensing contact or surface of the thermal sensor be in thermal contact with the tip 36. An exemplary thermal sensor 32 may be rated for 10 amps DC, 24 volts DC and 130° C.

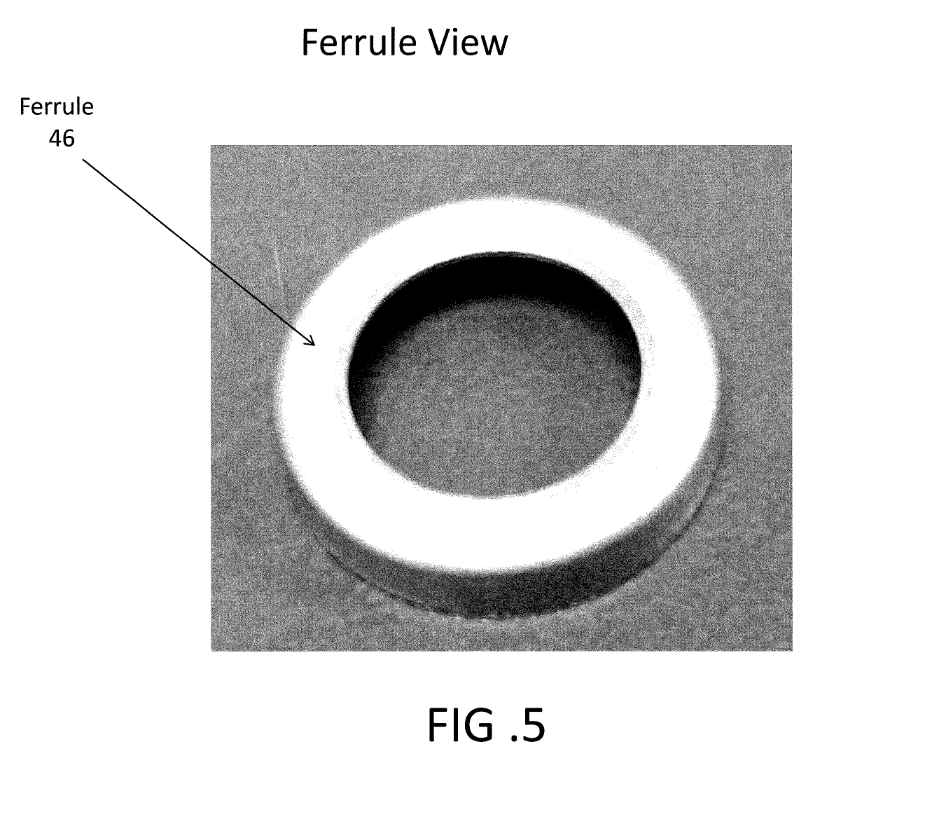

The components mentioned above are carried by a housing, for example a housing having an upper housing half 38 and a lower housing half 40. One end of the housing halves 38 and 40 is connected together with a conventional fastener. The other end is connected together by way of a screw cap 44 (FIG. 4) and a ferrule 46 (FIG. 5). The ferrule may be formed from stainless steel, for example.

One end of each of the housing halves 38 and 40 is formed with axially extending protuberance 48 and 50. The outer diameter of the protuberances 48 and 50 is selected to receive a screw cap 44 (FIG. 4) and the ferrule 46 (FIG. 5) when the housing halves 38 and 40 are put together. In particular, the protuberances 48 and 50 are threaded for receiving a screw cap 44, which keeps one end of the housing halves 38 and 40 together. The screw cap 44 may be formed from a metal, such as brass.

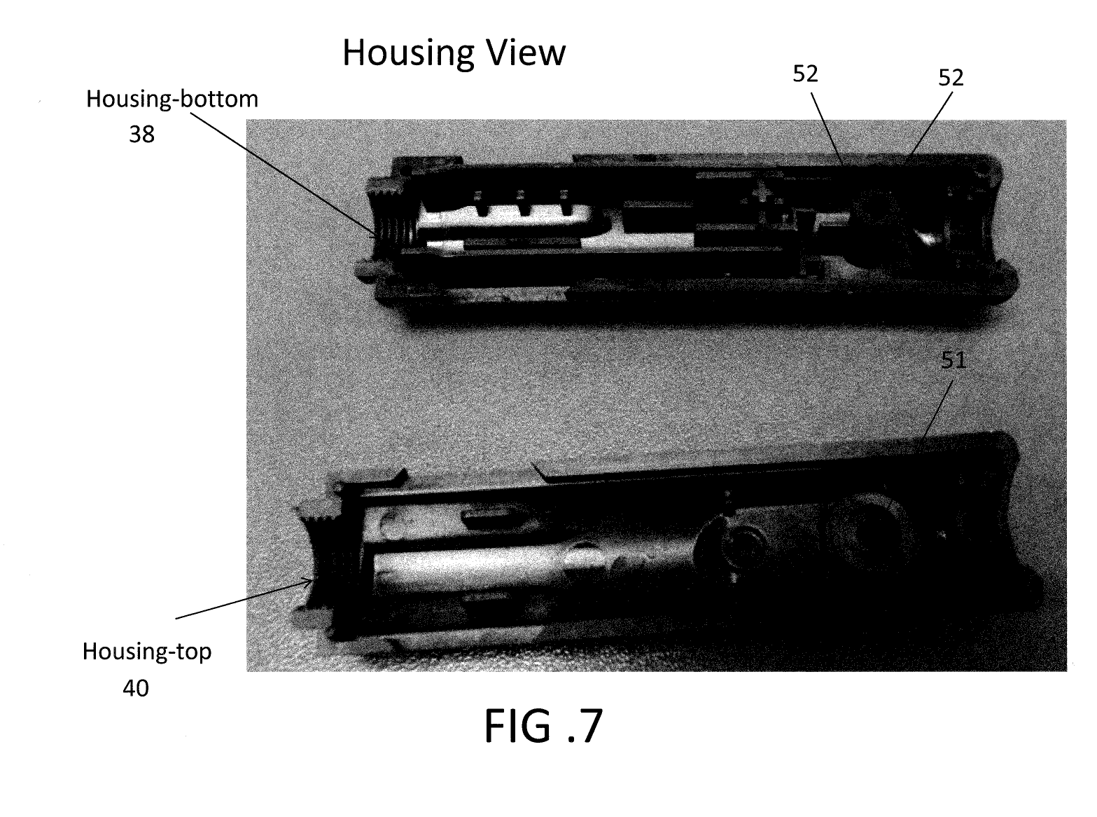

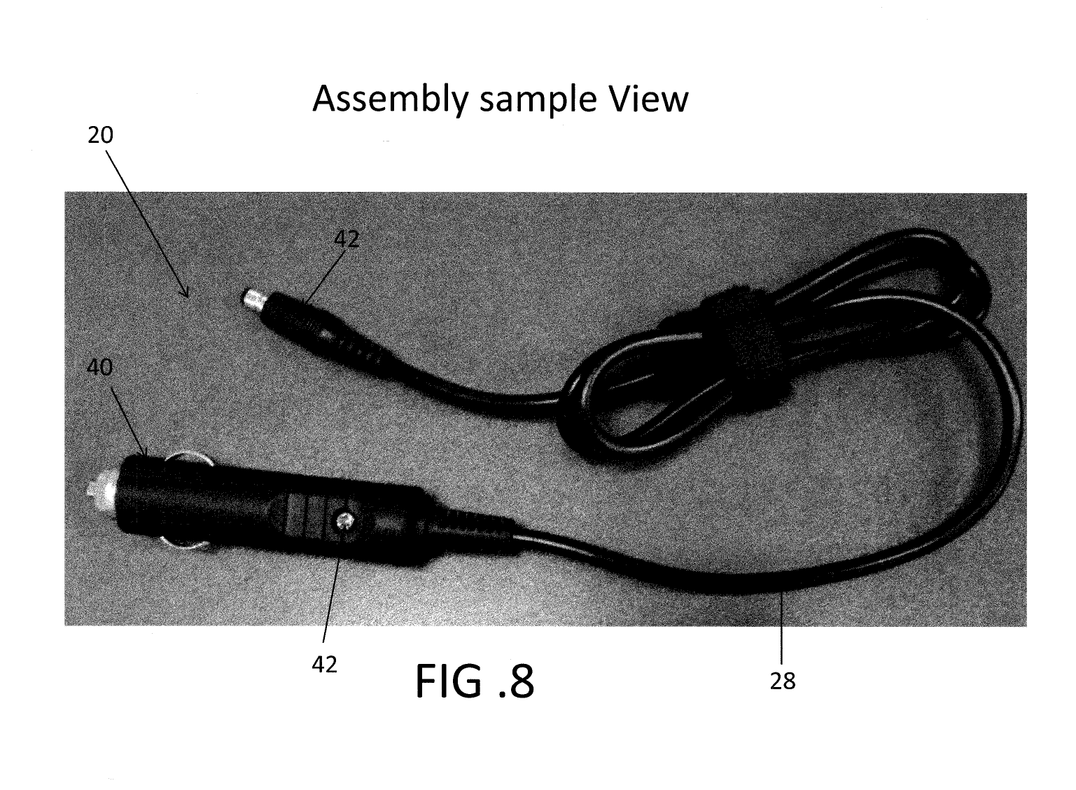

As mentioned above, the other end of the housing halves 38 and 40 (FIG. 7) are fastened together with a conventional fastener 42 (FIG. 8). The top housing half 38 is provided with a through hole 51 (FIG. 7) while the bottom housing half 40 is provided with a stand-off 52 that includes a threaded aperture 55 for receiving the fastener 42 (FIG. 8).

With reference to FIG. 2, the cable 28 is received in one end of the housing halves 38, 40. The housing halves 38, 40, are formed with a cable receiving aperture, when assembled together.

As is known in the art, the tip 36 is adapted to be connected to a positive contact of the vehicle socket (not shown). The negative contact 40 is configured to contact negative contact of the interior surface of the vehicle socket (not shown).

As shown best shown in FIG. 8, a complete cigarette lighter adapter assembly 20 is shown. One end of the cigarette lighter adapter assembly 20 is connected to the CLA adapter 40, described above. The other end of the cigarette lighter adapter assembly 20 is connected to a standard output power connector 42 by way of the cable 28 to provide a complete assembly.

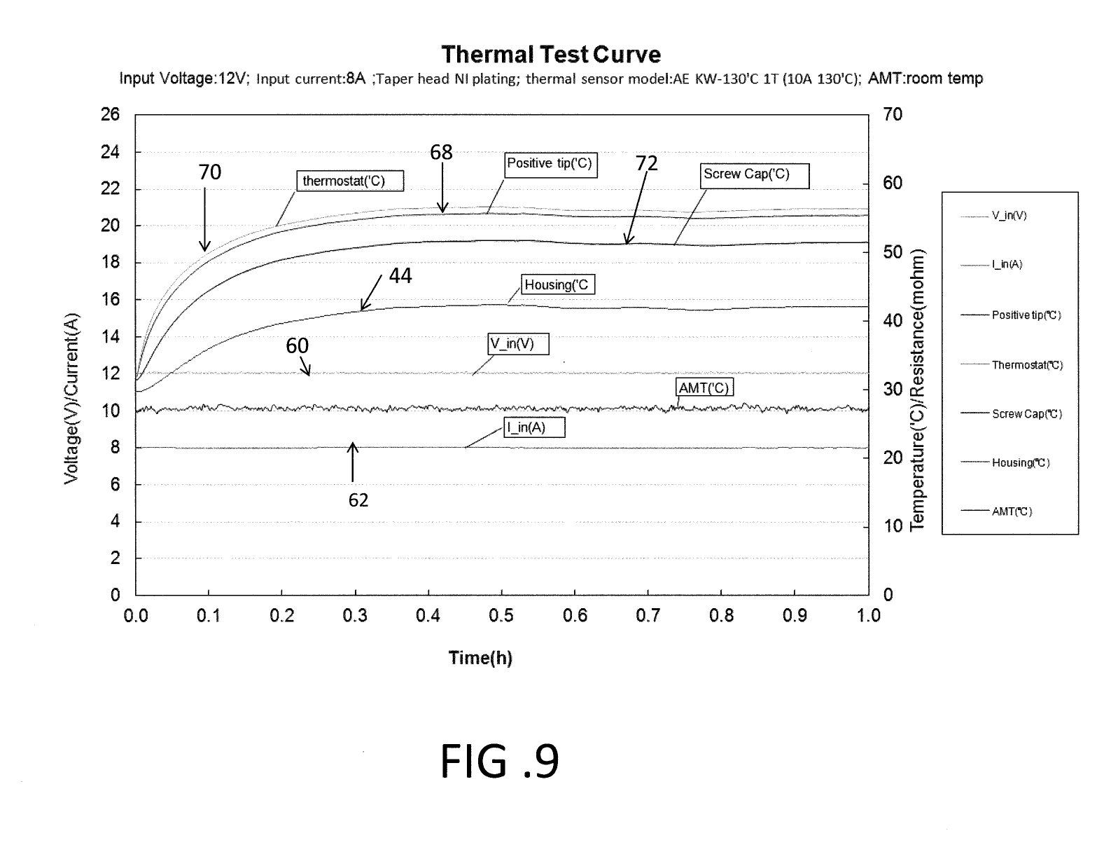

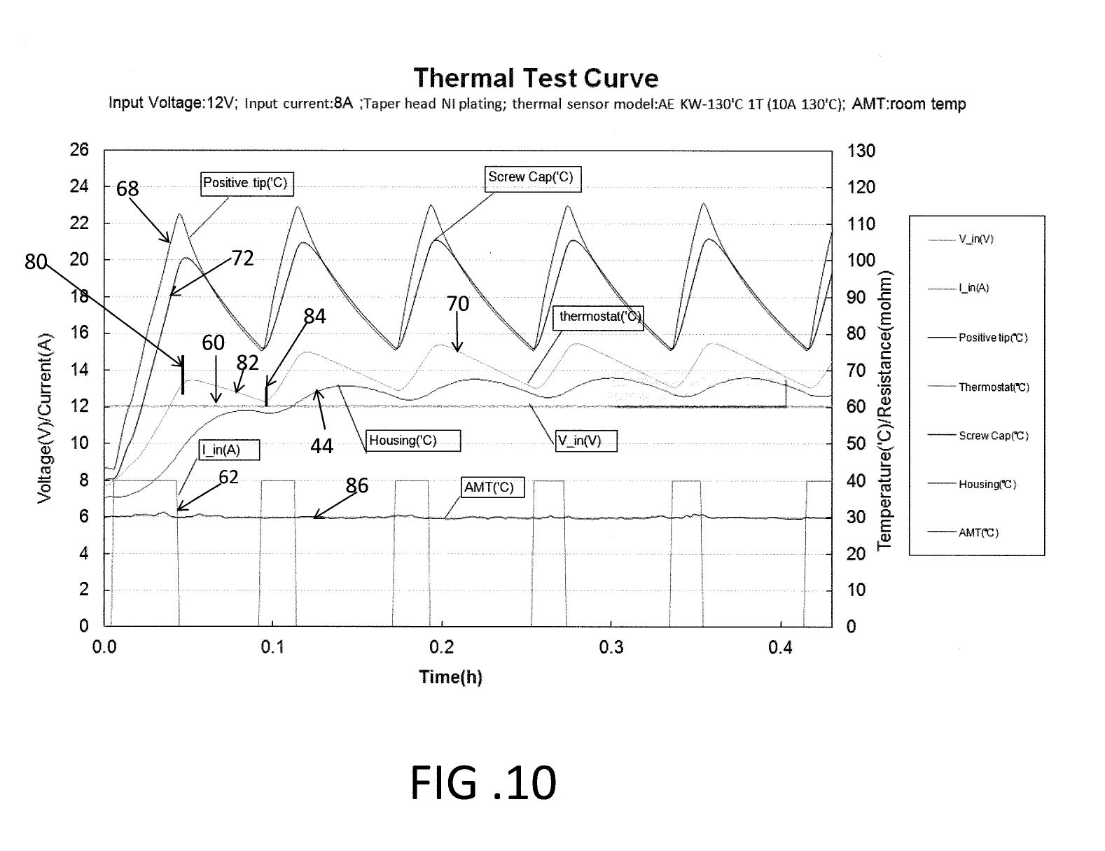

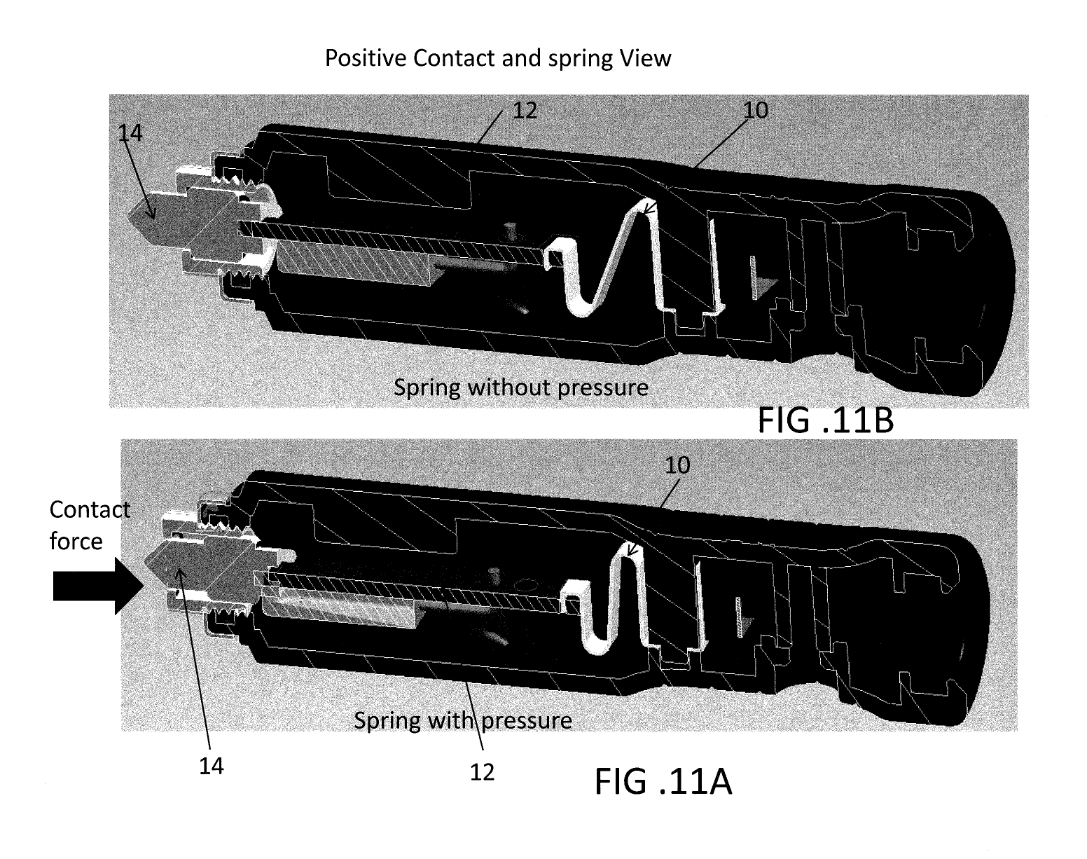

Temperature curves for normal and abnormal conditions for the CLA 40 are illustrated in FIGS. 9 and 10. FIG. 9 illustrates operation of the CLA adapter 40 under normal conditions while FIG. 10 illustrates operation of the CLA adapter 40 during abnormal conditions. The horizontal axes of both figures represent time in tenths of an hour. The vertical axes of both figures illustrate the output voltage in volts and the output current in amps. The vertical axis also represents temperature in degrees C. in 10 degree increments. In this example, the voltage, represented by the curve 60, and the current, represented by the curve 62, are fairly constant during both conditions.

Referring first to FIG. 9, an exemplary thermal test curve for an exemplary CLA is illustrated, as described above during normal conditions. As shown, the temperature of the screw cap 44, which is in contact with the tip 36 and represented by the curve 72, and the positive contact 22, as represented by the curve 68. During normal conditions, the final temp is stable. Since the thermal sensor 32 is in direct contact with the tip 36, which, in turn, is in contact with the screw cap 44, the temperature curve 70 for the thermal sensor 32 follows or tracks the temperature of the screw cap 44 and the positive contact 22. Under normal conditions, the thermal sensor 32 is not tripped and the input power remains connected to the CLA adapter 40.

Abnormal conditions can occur as a result of a poor electrical connection between the positive tip 36 and the socket. This condition can occur as a result of vibrations as well as conditions in which the positive spring contact 22 on the CLA adapter 40 do not have sufficient retention force to maintain a good contact between the positive tip 36 and the socket. This condition can cause increased contact resistance which can cause localized heating at the contact point of the tip 36, which will be unprotected by a fuse or circuit breaker protecting the circuit from an electrical standpoint. This localized heating can rise to the level of melting the plastic housing 38, 40 causing a catastrophic failure.

In order to prevent such a catastrophic failure, the CLA adapter 40 includes a thermal sensor 32, such as a bi-metallic strip, that is in thermal contact with the tip 36. The temperature trip point of the thermal sensor 32 is selected to be at a temperature less than the melting point of the housing 38, 40. As such, during abnormal conditions as described above, the thermal sensor disconnects the input power from the CLA adapter 40 at a temperature below the melting point of the housing 38, 40. As such, catastrophic failure of the CLA adapter 40 is averted under such abnormal conditions. The operation of the CLA adapter 40 during abnormal conditions is illustrated in FIG. 10.

In this example, a bi-metallic strip is used for the thermal sensor 32. Such bi-metallic strips contain two metallic strips of different metals that provide an electrical current path between the positive tip 36 and the positive contact 22 during normal conditions. When the temperature rises above its trip temperature, the metallic strips will separate and disconnect the input power to the CLA adapter 40. After the metal strips are separated, the metallic strips will subsequently cool down to a temperature in which the metallic strips once again provide an electrical current path between input power and the CLA adapter 40. The metallic strips will then heat up again and separate when the temperature reaches its temperature limit. The cycle will keep repeating as shown in FIG. 10. For brevity, only the first cycle is described. The remaining cycles of operation of the thermal sensor 32 are similar.

As shown in FIG. 10, once the CLA adapter 40 (with a device or appliance connected thereto) is plugged in, a steady state current of an exemplary 8 amps DC is supplied through the CLA adapter 40 to the device or appliance (not shown) connected to the CLA adapter 40, as indicated by the current curve 62. Assuming a loose connection between the positive tip 36 and the socket, the temperature of the positive tip 36 and the screw cap 44 will rise to relatively high temperature levels, as indicated by the curves 68 and 72, respectively. As shown in the exemplary curves illustrated in FIG. 10, the temperatures of these devices during an abnormal condition of the positive contact 22 can exceed the melting temperature of the housing 38, 40. During this time, the temperature of the housing 38, 40 also rises, as indicated by the curve 66. In accordance with an important aspect of the CLA adapter 40, the thermal sensor 32 trips, i.e. disconnects the input power from the CLA adapter 40 at a temperature below the melting point of the housing 38, 40.

As shown, the thermal curve 70 of the thermal sensor 32 tracks the thermal curve 66 of the housing 38, 40. As indicated by the point 80 on the thermal curve for the thermal sensor 32, the thermal sensor 32 disconnects the input power from the CLA adapter 40 at less than 70° C. This causes the current to drop to 0 amps, as shown on the curve 62. While the current is disconnected from the CLA adapter 40, the thermal sensor 32 cools as indicated by the segment 82 of the thermal curve 70 for the thermal sensor 32. This causes the temperatures of the positive tip 36 and the screw cap 44 to fall, as indicated by the curves 68 and 72. As the thermal sensor 32 cools to a temperature indicated by the point 84 on the thermal curve 70, the thermal sensor 32 reconnects the input power to the CLA adapter 40. This causes the current to turn on, as indicated by the curve 86. With the input power connected to the CLA adapter 40, the temperatures of the tip 36 and screw cap 44 rise again, as indicated by the curves 68 and 72. The temperature of the housing 38,40 also rises, as indicated by the curve 66. During this cycle, the temperature of the thermal sensor 32 also rises to its trip temperature at which point, the thermal sensor 32 trips, i.e. the bimetallic strips separate, and disconnect the input power from the CLA adapter 40. As shown, the cycles repeat. In accordance with an important aspect of the CLA adapter 40, the thermal curve 66 for the housing 38, 40 tracks the thermal curve 70 for the thermal sensor 32, and prevents the temperature of the housing 38, 40 from rising to the level of catastrophic failure.

Obviously, many modifications and variations of the present invention are possible in light of the above teachings. Thus, it is to be understood that within the scope of the appended claims, the invention may be practiced otherwise than as specifically described above.

What is claimed and desired to be secured by a Letters Patent of the United States is:

We claim:

1. A cigarette lighter adapter (CLA) comprising:
a positive contact formed as a spring for connection to and for providing a lateral spring force to a positive contact of a CLA socket;
a negative contact formed as a spring for connection to a negative contact of a CLA socket;
a tip serially connected to said positive contact, said tip for connection to a positive contact of a CLA socket;
a thermal sensor in thermal contact with said tip and electrically connected between said tip and said positive contact for disconnecting said CLA from said socket when the temperature of said tip exceeds a predetermined value; and
a housing configured to be at least partially received in said CLA socket and carry said positive contact, said negative contact, said tip and said thermal sensor

2. The CLA as recited in claim 1, further including a power connector and a cable connecting said CLA to said power connector.

3. The CLA as recited in claim 1, wherein said thermal sensor is thermally connected to said tip.

4. The CLA as recited in claim 1, wherein said thermal sensor is soldered to said tip.

5. The CLA as recited in claim 1, further including a printed circuit board for connecting said negative contact, said positive contact, said cable and said thermal sensor together.

6. The CLA as recited in claim 1, wherein said thermal sensor is a bi-metallic temperature sensor.

7. The CLA as recited in claim 1, wherein said thermal sensor is a thermocouple.

8. The CLA as recited in claim 1, wherein said thermal sensor is a resistive temperature device.

9. The CLA as recited in claim 1, wherein said housing is a two piece housing.

10. The CLA as recited in claim 1, wherein said housing is formed as mating housing halves

11. The CLA as recited in claim 10, wherein one end of said housing halves form a cable receiving aperture when assembled together.

12. The CLA as recited in claim 1, wherein the other end of said housing halves form axially extending protuberances, which are threaded.

13. The CLA as recited in claim 1, wherein said CLA further includes a ferrule and a screw cap that are configured to be received by said extending protuberances.

14. A method of making a cigarette lighter adapter comprising the steps of:
(a) connecting a thermally and electrically connecting tip in series with one end of a thermal sensor;
(b) connecting the other end of said thermal sensor to a positive contact;
(c) connecting a positive wire to said positive contact;
(d) connecting a negative wire to a negative contact; and
(e) placing said positive contact, said negative contact, said thermal sensor in a housing.

15. The method as recited in claim 14, wherein step (a) comprises:
(a) directly connecting said tip to said positive contact.

16. The method as recited in claim 14, wherein step (a) comprises:
(a) connecting said tip to said positive contact by way of a low resistance joint connection.

17. A method for protecting a cigarette lighter adapter (CLA) from excess temperatures when plugged into a CLA socket, the method comprising the step of:
(a) electrically disconnecting the CLA from the socket automatically as a function of temperature.

18. A CLA as recited in claim 1, further including a printed circuit board (PCB) for providing an electrical connection between the positive contact and said thermal sensor.

19. The CLA as recited in claim 18 wherein said positive contact is connected to said PCB by way of low resistance joint connections.

20. The CLA as recited in claim 19 wherein said thermal sensor is connected to said PCB by way of a low resistance joint connection.

21. The CLA as recited in claim 20, wherein said tip is connected to said PCB by way of a low resistance joint connection.
